(19) United States
(12) Patent Application Publication
(10) Pub. No.: US 2026/0216765 A1
(43) Pub. Date: Jul. 30, 2026

(54) APPARATUS AND SYSTEMS FOR WASTE REMOVAL

(71) Applicant: SAUDI ARABIAN OIL COMPANY, Dhahran (SA)

(72) Inventors: Khalid Almasoud, Dammam (SA); Abdulaziz Al-Salem, Dammam (SA); Abdulrahman Almotairy, Dhahran (SA)

(73) Assignee: SAUDI ARABIAN OIL COMPANY, Dhahran (SA)

(21) Appl. No.: 19/039,279

(22) Filed: Jan. 28, 2025

(51) Int. Cl. B08B 9/093

(52) U.S. Cl. CPC B08B 9/0933

(57) ABSTRACT

Methods and systems employ an emulsification fork. The emulsification fork includes a fork body configured to transport a pressurized fluid. The emulsification fork includes a fork arm protruding from the fork body. The emulsification fork includes an emulsification nozzle fluidly coupled to the fork arm and configured to jet the pressurized fluid to emulsify the waste yielding an emulsified waste. The emulsification fork includes a pressurized fluid channel disposed throughout the fork body, the fork arm, and the emulsification nozzle and configured to transport the pressurized fluid. The emulsification fork includes a vacuum port disposed on the fork body and configured to remove a portion of the emulsified waste. The emulsification fork includes a vacuum channel disposed throughout the vacuum port and configured to transport the portion of the emulsified waste.

### BACKGROUND

In many industries, such as the oil and gas industry, waste is produced. For example, while producing oil and gas from a hydrocarbon reservoir, low pressure and temperature hydrocarbon reservoirs may experience the formation of a waste commonly called sludge. The waste may accumulate in waste receptacles such as waste ponds, surface waste impoundment, and waste tanks. The waste, such as solid waste and/or sludge, is difficult to clean from the waste receptacles.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to an emulsification fork for removing waste from a waste receptacle. The emulsification fork includes a fork body, a fork arm protruding from the fork body, an emulsification nozzle fluidly coupled to the fork arm, a pressurized fluid channel, a vacuum port, and a vacuum channel. The fork body is configured to transport a pressurized fluid. The emulsification nozzle is configured to jet the pressurized fluid to emulsify the waste yielding an emulsified waste. The pressurized fluid channel is disposed throughout the fork body, the fork arm, and the emulsification nozzle and configured to transport the pressurized fluid. The vacuum port is disposed on the fork body and configured to remove a portion of the emulsified waste. The vacuum channel is disposed throughout the vacuum port and configured to transport the portion of the emulsified waste.

In some aspects, the techniques described herein relate to a cleaning system for removal of waste from a waste receptacle. The cleaning system includes an emulsification fork, a pressurizing device, and a vacuum device. The emulsification fork includes a fork body, a fork arm protruding from the fork body, an emulsification nozzle fluidly coupled to the fork arm, a pressurized fluid channel, a vacuum port, and a vacuum channel. The fork body is configured to transport a pressurized fluid. The emulsification nozzle is configured to jet the pressurized fluid to emulsify the waste yielding an emulsified waste. The pressurized fluid channel is disposed throughout the fork body, the fork arm, and the emulsification nozzle and configured to transport the pressurized fluid. The vacuum port is disposed on the fork body and configured to remove a portion of the emulsified waste. The vacuum channel is disposed throughout the vacuum port and configured to transport the portion of the emulsified waste. The emulsification fork is configured to be disposed within the waste receptacle. The pressurizing device is fluidly connected to the emulsification fork via a fluid flowline and configured to pressurize a cleaning fluid. The vacuum device is fluidly connected to the vacuum port and configured to provide suction to the vacuum port.

In some aspects, the techniques described herein relate to a method for cleaning a waste receptacle. The method includes disposing an emulsification fork within the waste receptacle. The method includes initiating a pressurizing device fluidly connected to the emulsification fork and configured to pressurize a cleaning fluid yielding a pressurized fluid. The method includes jetting, using an emulsification nozzle of the emulsification fork, the pressurized fluid into the waste receptacle containing waste yielding an emulsified waste. The method includes initiating a vacuum device fluidly connected to the emulsification fork and configured to provide suction to a vacuum port of the emulsification fork. The method includes removing a portion of the emulsified waste via a vacuum channel of the vacuum port to a waste container fluidly connected to the vacuum port via a vacuum flowline.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example production system that may use a cleaning system for removal of waste in accordance with one or more embodiments.

FIG. 2 depicts a perspective view of an emulsification fork in accordance with one or more embodiments.

FIG. 3 depicts a cross-sectional view of an emulsification fork in accordance with one or more embodiments.

FIG. 4 depicts a cleaning system for waste removal in accordance with one or more embodiments.

FIG. 5 depicts a cleaning flowchart for waste removal in accordance with one or more embodiments.

FIG. 6 depicts a computer system that may be used in relation to various embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

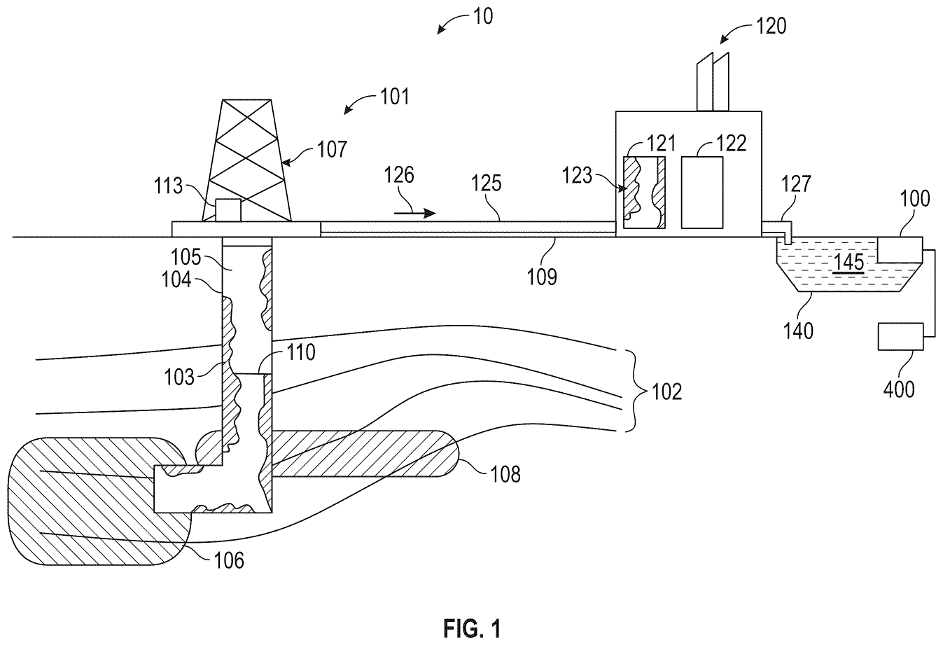

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments herein are directed toward apparatuses, systems, and methods for removal of waste from waste receptacles. Apparatuses, systems, and methods include cleaning waste from a waste receptacle such as, but not limited to, waste ponds, surface waste impoundments, and waste tanks. Embodiments herein may include transporting the waste after removal for treatment and disposal and/or hydrocarbon recovery and recycling.

Based on disclosures herein, it will be apparent to those skilled in the art that references to waste may include solid waste and/or semi-solid waste that includes at least a portion of the waste being liquid-based waste. Semi-solid waste may include waste commonly known as sludge and that any embodiments disclosed herein may include removal of various forms of waste such as solid waste and/or semi-solid waste.

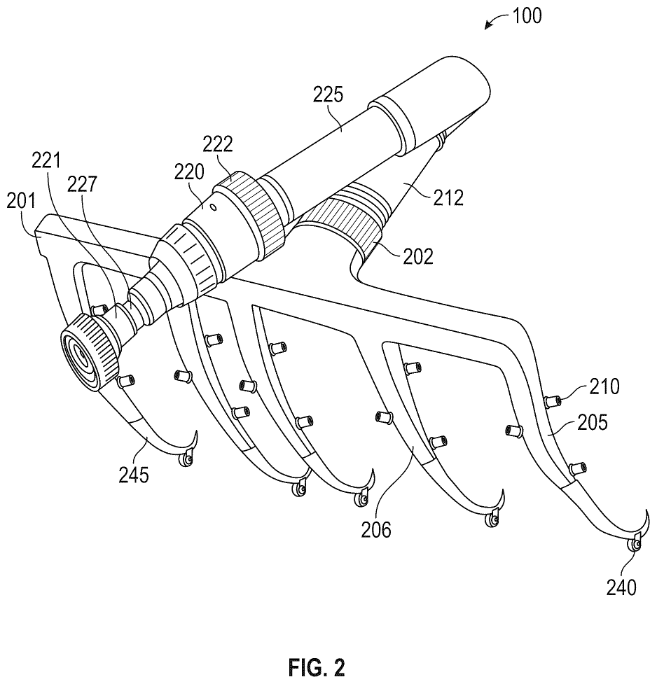

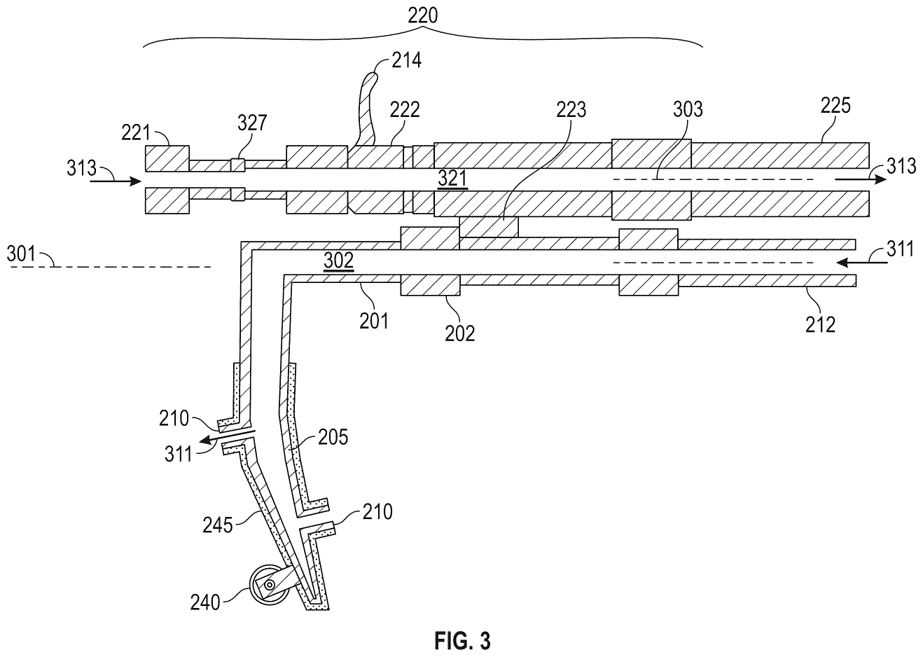

A non-limiting example of waste formation from oil and gas operations is shown in FIG. 1, which also depicts an example of a production system (10) of hydrocarbons, such as oil and/or gas. The production system (10) may include a production plant (120) and/or a production well (101) located above a hydrocarbon reservoir (102). The production system (10) may include one or more waste receptacles (140) and use a system for removal of waste from waste receptacles (hereafter “cleaning system” (400)) in accordance with one or more embodiments. The cleaning system (400) includes an emulsification fork (100) as described in relation to FIG. 2 and FIG. 3 and accompanying description.

In some embodiments, the production well (101) may include framework such as an oil rig (107) and a choke manifold (113) in fluid communication with a target zone of formation (106) and a wellbore (104) to extract production fluids (126) such as hydrocarbons (108). The wellbore (104) includes a bored hole (i.e., a borehole) that extends from the surface (109) towards the target zone of the formation (106). During drilling operations, drilling fluid is circulated through the wellbore (104) to facilitate smooth drilling operations. The production well (101) may include casing (110) inserted into the wellbore (104) to support the wellbore (104) and to prevent instability of the wellbore (104). For example, the casing (110) may be cemented into the wellbore (104) to prevent cave-ins and/or unplanned formation fluids entering the wellbore (104). During production operations, substances (e.g., water and other chemicals used for oil recovery) may be injected into the wellbore (104) and travel through a well (105) to the target zone of the formation (106). Due to well damage or solid accumulation within the wellbore (104) during operation, sludge (103) may accumulate on the inner surface of the wellbore (104) and/or the casing (110).

In some embodiments, the production plant (120) may include processing systems and equipment that may be distributed on either onshore production facilities and/or offshore production facilities. In the case of an oil-bearing reservoir for example, the production plant (120) may refer to various types of industrial plants such as, but not limited to, crude oil stabilization plants, petroleum depots, oil refineries, and/or blending plants. For example, the production facility may be an oil refinery including heat exchangers (121) for distillation of the production fluid (126) into different products (e.g., gasoline, diesel fuel, jet fuel). Processing operations, such as distillation of the production fluid (126), may produce by-products such as waste that may include solid waste and/or semi-solid waste such as sludge. Based on the disclosure herein, one of ordinary skill in the art will recognize the various systems and processes in relation to different embodiments where the formation of waste such as solid waste and/or semi-solid waste may occur and that the example production system illustrated in FIG. 1 should not be considered limiting as to the scope of the invention.

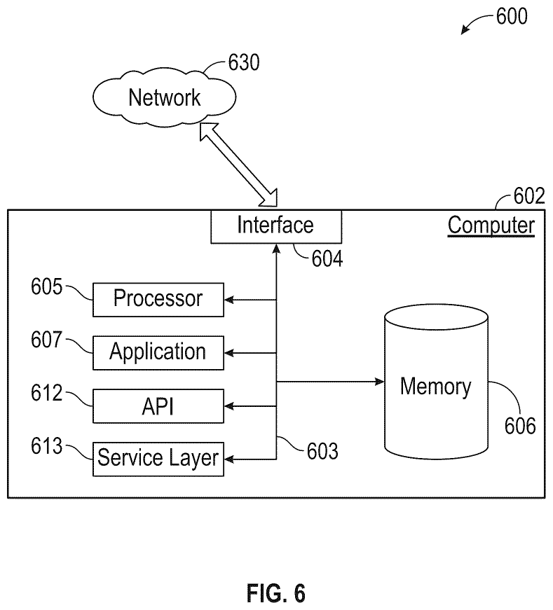

The production plant (120) may include a plant control system (122) and production fluid processing equipment that includes hardware and/or software for extracting, separating, treating, and/or disposing of different components of the production fluid (126) (e.g., oil, gas, and/or water) associated with production fluid processing. More specifically, the production plant (120) may extract produced water during the separation of oil or gas from the production fluid (126) acquired from the production well (101). In some embodiments, the plant control system (122) may include a computer system such as computer system (600) as described in relation to FIG. 6 and accompanying description.

With respect to plant control systems, the plant control system (122) may include hardware and/or software that operates equipment, such as at the production well (101) or in the production plant (120). Examples of plant control systems may include one or more of the following: an emergency shut down (ESD) system, a safety control system, a supervisory control and data acquisition (SCADA) system, a video management system (VMS), process analyzers, other industrial systems, etc.

With regard to waste, waste (145), including solid waste (123) and/or semi-solid waste such as sludge (103), may include a collection of chemical materials restricting the flow of fluids within production and processing equipment of the production plant (120) and production lining and/or completion equipment of a production well that often impedes production and/or drilling operations. For example, waste (145) from the production well (101), may be heterogeneous waste that may be classified into two main components: organic sludge and inorganic scale. Inorganic scale is commonly formed from the aqueous phase of reservoir fluids. In contrast, organic sludge is water repellant, often waxy matter, which does not need the presence of an aqueous solution to form in a reservoir. Based on the disclosure herein, it will be apparent to those skilled in the art of the various forms of waste generated in production facilities and that the examples listed here should not be considered limiting as to the scope of the disclosure. In some embodiments, the waste (145) may be separated into multiple layers composing of different materials, for example, a top oily layer and a sludge bottom layer. Based on the disclosure herein, it will be apparent to those skilled in the art the different layers are possible based on various components of waste produced by the various production facilities and that the listed layers are not meant to be limiting to the scope of the invention.

Waste may be transported, for example, using pipelines such as production pipelines (125) and/or waste pipelines (127), out of the production well (101) and/or the production plant (120). Waste may be extracted from the production well (101) and/or the production plant (120) using various waste treatments, such as acid treatments, known to those skilled in the art. The waste (145) may be stored in a waste receptacle (140) such as, but not limited to, waste ponds, surface waste impoundment, and waste tanks. The waste receptacle (140) may include a waste receptacle liner (not shown) configured to provide protection from waste leakage out of the waste receptacle (140) and into the environment. The waste receptacle liner may be constructed of any material suitable for providing leak protection and known to those skilled in the art.

FIG. 2 depicts the emulsification fork (100) in accordance with one or more embodiments. The emulsification fork (100) includes a fork body (201) and one or more fork arms (e.g., a fork arm (205) and an additional fork arm (206)) protruding from the fork body (201). In some embodiments, the fork body (201) and each fork arm (205, 206) may be integrally formed. In some embodiments, each fork arm (205, 206) may be detachably connected to the fork body (201). The one or more forks arms (205, 206) may be smoothly curved. The fork body (201) may include a flowline connector (202) configured to receive and connect to a pressurized fluid flowline (212). The flowline connector (202) is fluidly connected to the fork body (201) and configured with attachment components, such as threads or compression fittings, for attaching to the pressurized fluid flowline (212) configured with corresponding attachment components. The pressurized fluid flowline (212) may be either a rigid flowline or a flexible flowline configured to flex and/or coil to facilitate disposing of the attached fork in the waste receptacle (140). The pressurized fluid flowline (212) may be constructed of corrosion resistant material such as flexible stainless-steel mesh, rubber, and the like.

In accordance with one or more embodiments, the emulsification fork (100) includes one or more emulsification nozzles (210) fluidly coupled to the one or more fork arms (205, 206) and configured to jet a pressurized fluid to emulsify the waste (145) yielding an emulsified waste. Each emulsification nozzle (210) may be any suitable shape for emulsifying the waste (145). Each fork arm (205, 206) may have the one or more emulsification nozzles (210) disposed on each fork arm (205, 206). Each emulsification nozzle (210) is configured to jet a pressurized fluid at various angles suitable for dislodging the waste (145) from lateral sides and bottoms of the waste receptacle (140).

In some embodiments, each emulsification nozzle (210) may be constructed with a shape optimized for waste breakdown, emulsification, and dispersion. The emulsification nozzle (210) may include a multi-angle configuration (not shown) to enhance emulsification of the waste (145) by creating turbulent flow of pressurized fluid and maximizing contact with waste particles.

In accordance with one or more embodiments, the emulsification fork (100) includes a vacuum port (220) disposed on the fork body (201) and configured to remove at least a portion of an emulsified waste. The vacuum port (220) may be fluidly connected to a vacuum flowline (225). The vacuum port (220) may include a port connector (222) configured to receive and fluidly connect to the vacuum flowline (225). The vacuum flowline (225) is configured to transport a portion of an emulsified waste from the waste receptacle (140). The port connector (222) is configured with attachment components, such as threads or compression fittings, for attaching to the vacuum flowline (225) configured with corresponding attachment components. The vacuum flowline (225) may be a rigid flowline, or a flexible flowline configured to flex and/or coil to facilitate disposing of the attached fork in the waste receptacle (140). The vacuum flowline (225) may be constructed of corrosion-resistant material such as flexible stainless-steel mesh, rubber, and the like.

In some embodiments, the vacuum port (220) is operatively connected to the fork body (201) using a connection block (223). The connection block (223) may be attached to the vacuum port (220) and the fork body (201) by various processes known to those skilled in the art such as welding, sintering, brazing, bolt, screws, and the like.

In some embodiments, the vacuum port (220) includes a vacuum nozzle (221) configured to suction a portion of an emulsified waste into the vacuum port (220). The vacuum nozzle (221) may be shaped in any suitable shape to facilitate removal of a portion of an emulsified waste. In some embodiments, the vacuum nozzle (221) may be detachably connected to the vacuum port (220) via a nozzle connector (227). The nozzle connector (227) is configured to release the vacuum nozzle (221) for the purpose of maintenance and replacement.

In some embodiments, the emulsification fork (100) may include a quick-release latch (214) configured to release the vacuum port (220) and/or the vacuum nozzle (221) from the emulsification fork (100). The quick-release latch (214) may include a restriction band configured to receive the vacuum flowline (225). When in the open configuration as shown in FIG. 2 and FIG. 3, the quick-release latch (214) decompresses the restriction band around the first end of the vacuum flowline (225). When in the closed configuration, the quick-release latch (214) compresses the restriction band around the first end of the vacuum flowline (225) so as to fluidly connect the vacuum port (220) and the vacuum flowline (225).

In some embodiments, the fork body (201) and/or at least one of the fork arms (205, 206) may be coated, at least partially, by a protective coating (245). The protective coating (245) may be any suitable material configured to provide protection the waste receptacle (140) and/or the waste receptacle liner. The material may include, for example, silicone-based products, rubber, and the like.

In some embodiments, the emulsification fork (100) may include a wheel (240) disposed on at least one of the fork arms (205, 206). The wheel (240) is configured to rotate and facilitate maneuvering of the emulsification fork (100) during cleaning operations and provide protection to the waste receptacle (140) and/or waste receptacle liner. Maneuvering may include rolling over the waste receptacle liner and pivoting the emulsification fork (100) for change of direction for cleaning. The wheel (240) may include a wheel bracket configured to attach the wheel (240) to one or more of the fork arms (205, 206). The wheel (240) may also include a wheel axis configured to rotationally attach the wheel (240) to the wheel bracket. In some embodiments, the wheel bracket may be coated in the protective coating (245). The wheel may be disposed on a periphery of a distal end of the one or more fork arms (205, 206). The distal end is the end furthest from the fork body (201) along the fork arm (205 and/or 206). The wheel bracket may be attached to the fork arm (205) by any process suitable for attaching such as, but not limited to, welding, sintering, brazing, bolting, or screwing.

FIG. 3 depicts a cross-sectional view of the emulsification fork (100) in accordance with one or more embodiments. In some embodiments, the one or more fork arms (205, 206) may be angled substantially perpendicular to the fork body (201). In some embodiments, the one or more fork arms (205, 206) may be angled obliquely in relation to a fork longitudinal axis (301) of the fork body (201).

In accordance with one or more embodiments, the emulsification fork (100) includes a pressurized fluid channel (302) disposed throughout the fork body (201), each fork arm (205, 206), and each emulsification nozzle (210). In some embodiments, the pressurized fluid channel (302) may also be disposed through the pressurized fluid flowline (212) when the pressurized fluid flowline (212) is fluidly connected to the emulsification fork (100). The pressurized fluid channel (302) is configured to transport a pressurized fluid, such as pressurized fluid (311), to each emulsification nozzle (210) via the fork body (201), and each fork arm (205, 206). Each emulsification nozzle (210) is configured to jet the pressurized fluid (311) to emulsify the waste (145) yielding an emulsified waste, such as emulsified waste (313).

In accordance with one or more embodiments, the emulsification fork (100) includes a vacuum channel (321) disposed throughout the vacuum port (220). In some embodiments, the vacuum channel (321) may be disposed throughout the vacuum flowline (225) when the vacuum flowline (225) is fluidly connected to the vacuum port (220). The vacuum channel (321) is configured to transport a portion of the emulsified waste (313) through the vacuum port (220) and the vacuum flowline (225). In some embodiments, the vacuum channel (321) is disposed throughout the vacuum nozzle and nozzle connector. In some embodiments, the nozzle connector (227) may be a pivot connector (327) configured to adjust the vacuum nozzle (221) to be angled obliquely to, i.e., above or below, a port longitudinal axis (303) of the vacuum port (220). The pivot connector (327) may include a ball and socket joint fluidly connected together. The vacuum nozzle (221) may be angled so as to target different layers of waste, for example, an oily top layer and/or an emulsified waste bottom layer. Such adjustability ensures precise sludge removal tailored to various waste compositions and enables efficient oily recovery.

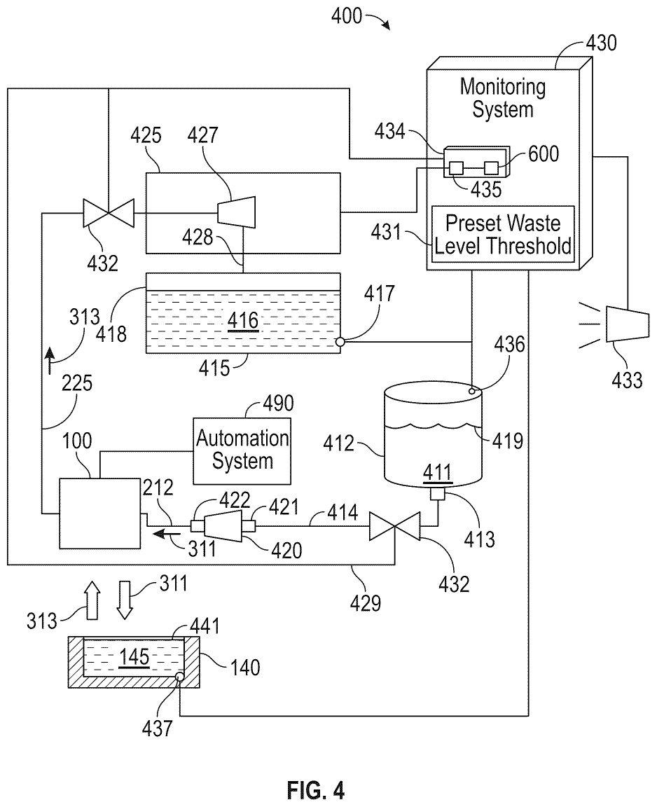

FIG. 4 depicts a block diagram of the cleaning system (400) in accordance with one or more embodiments. The cleaning system (400) may be configured to pressurize a fluid, jet pressurized fluid to emulsify waste, and/or remove emulsified waste to a waste container for treatment and/or disposal. Based on the disclosure herein, it will be apparent to one skilled in the art of various configurations of a cleaning system, and that the particular configuration of the cleaning system (400) should not be considered limiting.

The cleaning system (400) may include the emulsification fork (100) configured to be disposed in the waste receptacle (140) in accordance with one or more embodiments. The emulsification fork (100) may be disposed in the waste receptacle (140) during cleaning operations and then removed between cleaning operations. In some embodiments, the emulsification fork (100) may be disposed permanently in the waste receptacle (140) and operated during cleaning operations.

In some embodiments, the cleaning system (400) includes a fluid reservoir (412) configured to store a cleaning fluid (411). The cleaning fluid (411) may include, but not limited to, water, an emulsifying agent, and/or a cleaning agent. The fluid reservoir (412) may include a cleaning fluid outlet (413) configured to discharge an outflow of the cleaning fluid (411). The fluid reservoir (412) may be fluidly connected to a cleaning fluid flowline (414) via the cleaning fluid outlet (413).

The cleaning system (400) includes a pressurizing device (420) such as a pressure pump. The pressurizing device (420) may be fluidly connected to the emulsification fork (100) via the pressurized fluid flowline (212). The pressurizing device (420) is configured to pressurize the cleaning fluid (411) yielding a pressurized fluid, such as the pressurized fluid (311). The pressurizing device (420) may be a hydraulic pump, pneumatically powered pump, air-driven liquid pump, and the like. The pressurizing device (420) may include a cleaning fluid inlet (421) configured to receive the cleaning fluid (411). The pressurizing device (420) may include a pressurized fluid outlet (422) configured to discharge the pressurized fluid (311). The cleaning fluid inlet (421) may be fluidly connected to the cleaning fluid outlet (413) of the fluid reservoir (412) via the cleaning fluid flowline (414) configured to transport the cleaning fluid (411). The pressurized fluid outlet (422) may be fluidly connected to the emulsification fork (100) via the pressurized fluid flowline (212). In some embodiments, the cleaning fluid inlet (421) may include a filter to prevent particles, debris, and the like from entering the pressurizing device (420).

The cleaning system (400) includes a vacuum system (425) having a vacuum device (427) configured to provide suction to the vacuum port (220). The vacuum device (427) may be fluidly connected via the vacuum flowline (225) to the vacuum port (220) and configured to provide suction to the vacuum port (220). The vacuum device (427) may include a vacuum inlet configured to receive the emulsified waste (313) via the vacuum flowline (225). In some embodiments, the vacuum device (427) may be a vacuum pump configured to provide suction to the vacuum port (220) to remove the waste (145) from the waste receptacle (140). The vacuum system (425) may include vacuum hardware equipment configured to remove the waste (145) from the waste receptacle (140). Vacuum hardware equipment may include, but not limited to, the vacuum device (427), vacuum pipes, fittings, wires, cables, and filters. The filters may be arranged to prevent solid particles of waste with a diameter large enough to be detrimental to the vacuum device (427) from entering the vacuum device (427).

In some embodiments, the vacuum device (427) and the pressurizing device (420) are configured to operate sequentially. The pressurizing device (420) may operate during cleaning operations to emulsify the waste (145), turn off, and then the vacuum device (427) may be initiated and operated to remove a portion of the emulsified waste (313). In some embodiments, the vacuum device (427) and the pressurizing device (420) are configured to operate simultaneously to emulsify the waste (145) and remove the portion of the emulsified waste (313).

The cleaning system (400) may include a reservoir sensor (436) configured to monitor a fluid level (419) of the fluid reservoir (412). The reservoir sensor (436) is operatively disposed on the fluid reservoir (412). The fluid level (419) may include a height from the base of the fluid reservoir (412) and/or a reservoir capacity reading of the fluid reservoir (412), such as in the range from 0-100 percent (%) of reservoir capacity.

The cleaning system (400) may include a receptacle sensor (437) operatively disposed on the waste receptacle (140). The receptacle sensor (437) is configured to obtain a waste level (441) of the waste receptacle (140). The waste level (441) may include a height from the base of the waste receptacle (140) and/or a receptacle capacity reading of the waste receptacle (140), such as in the range from 0-100% of receptacle capacity.

The cleaning system (400) may include a waste container (415) fluidly connected to the vacuum device (427) via a waste flowline (428). The waste container (415) is configured to store the portion of the emulsified waste (313) removed from the waste receptacle (140) yielding a stored waste (416). In some embodiments, the waste container (415) may include a storage sensor (417). The storage sensor (417) is operatively disposed on the waste container (415). The storage sensor (417) is configured to obtain a storage level (418) of the stored waste (416) within the waste container (415). The storage level (418) may include a height from the base of the waste container (415) and/or a storage capacity reading of the waste container (415), such as in the range from 0-100% of storage capacity.

In some embodiments, the stored waste (416) may be transported by transport vehicle or treatment flowlines to a treatment facility. The treatment facility is configured to treat and/or dispose of the stored/treated waste that includes various treatment processes known to those skilled in the art. In some embodiments, the waste may be transported to hydrocarbon recovery facilities to separate any residual hydrocarbons from the waste (145). The waste (145) may be transported to recycling facilities for recycling of different components of the waste such as tar recycling and water recycling.

The cleaning system (400) may include a monitoring system (430) and a cleaning control system (434), each operatively connected to various components of the cleaning system such as the emulsification fork (100), the vacuum system (425) and the pressurizing device (420). The monitoring system (430) may be communicably coupled with the cleaning control system (434). The monitoring system (430) may use flow measurement devices that may continuously measure the flow within the cleaning system (400). The flow monitoring devices may include precision pressure gauges. These gauges may provide a data logging feature to monitor and analyze pressure and pressure changes within the cleaning system (400). The monitoring system (430) may include a computer system such as computer system (600) as described in relation to FIG. 6. The monitoring system (430) may be configured with monitoring specific hardware and software for monitoring the cleaning system (400).

In some embodiments, the monitoring system (430) may include a display showing all system parameters, such as pressure parameters. The flow measurement data may be electronically transmitted to a programmable flow controller (hereafter “controller”) (435) included in the cleaning control system (434). The controller (435) may be an electrically actuated switch. The controller (435) may be digitally set to send a signal when the pressure in the cleaning system (400) meets a target pressure tolerance. The controller (435) may include programmable pressure controls. The programmable pressure controls may include programmable instructions for valves, pumps, and the like. The controller (435) is configured to control the operation of various components of the cleaning system (400) such as the emulsification fork (100), the pressurizing device (420) and the vacuum device (427). The pressurizing device (420), the waste container (415), the monitoring system (430), and the cleaning control system (434) are all disposed in operative proximity to the emulsification fork (100).

In some embodiments, the monitoring system (430) may be communicably coupled to one or more sensors (e.g., the reservoir sensor (436), the receptacle sensor (437), and the storage sensor (417)). The monitoring system (430) is configured to monitor each of the sensors (436, 437, 417).

The cleaning system (400) may include one or more control valves (432) configured to control the flow of fluids (e.g., cleaning fluids, pressurized fluids, and emulsified waste) within the cleaning system (400). The one or more control valves (432) may be operatively connected to the cleaning control system (434) via control lines (429) configured to communicate instructions and information between the cleaning control system (434) and various components of the cleaning system (400) (e.g., the emulsification fork (100), the fluid reservoir (412), the pressurizing device (420), the waste receptacle (140), and/or the waste container (415)). For example, the control valves (432) may be fully opened to enable unrestricted flow of cleaning fluids from the fluid reservoir (412) and/or the unrestricted flow of the emulsified waste (313) to the waste container (415). The control valves (432) may be partially opened to partially restrict (or “throttle”) the flow of fluids (e.g., the cleaning fluid (411) and/or the emulsified waste (313)) from the fluid reservoir (412), the pressurizing device (420) and/or the waste receptacle (140), and the control valves (432) may be fully closed to fully restrict (or “block”) the flow of fluids from the fluid reservoir (412), the pressurizing device (420) and/or the waste receptacle (140), and throughout the cleaning system (400).

In some embodiments, the monitoring system (430) is configured to determine if the waste level (441) is greater than a preset waste level threshold (431). In some embodiments, the monitoring system is configured to automatically initiate the pressurizing device (420) and the vacuum device (427) to emulsify the waste (145) and remove the portion of the emulsified waste (313) from the waste receptacle (140) if the waste level (441) is greater than the preset waste level threshold (431), for example, the preset waste level threshold (431) is set at 90% capacity of the waste receptacle (140). The preset waste level threshold (431) may be set by input from a user using a user interface of the monitoring system (430).

Further, in one or more embodiments, the monitoring system (430) may include an alarm (433). The alarm (433) is configured to provide notifications to operators. The alarm (433) may be a digital alarm that sends notification to a device such as a mobile device. The alarm (433) may be a sound device that emits sound notifications. The notifications may be audible and/or visual alarms. The notifications may be operational actions such as starting the pressurizing device (420) and the vacuum device (427) if the waste level (441) is greater than the preset waste level threshold (431), for example, the waste level (441) is greater than 90% full of the waste receptacle (140). The alarm (433) is operatively connected to the monitoring system (430). The alarm (433) is configured to receive commands from the cleaning control system (434).

In some embodiments, a control system (e.g., cleaning control systems and plant control systems) may include a programmable logic controller (PLC) that may control valve states, waste levels, fluid levels, flowline and pipe pressures, warning alarms, pressure releases and/or various hardware components for implementing a gas flowline. Thus, a PLC may be a ruggedized computer system with functionality to withstand vibrations, extreme temperatures, wet conditions, and/or dusty conditions, such as those around a gas plant, gas well, and/or a gathering system.

With respect to distributed control systems, a distributed control system may be a computer system for managing various processes at a facility using multiple control loops. As such, a distributed control system may include various autonomous controllers (such as remote terminal units (RTUs)) positioned at different locations throughout the facility to manage cleaning and production operations and monitor various processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, which connects sensors and/or actuators using network connections to perform various processes in an automation system such as automation system (490) as described in relation to FIG. 4.

Keeping with control systems, a control system may be coupled to facility equipment. Facility equipment may include various machinery such as one or more hardware components, such as pipe and flowline components, which may be monitored using one or more sensors. Examples of hardware components coupled to a control system may include crude oil preheaters, heat exchangers, pumps, valves, and compressors, among various other types of hardware components. Hardware components may also include various network elements or control elements for implementing control systems, such as switches, routers, hubs, PLCs, remote terminal units, user equipment, or any other technical components for performing specialized processes. Examples of sensors may include pressure sensors, flow rate sensors, temperature sensors, rotary switches, position sensors, microswitches, etc.

In accordance with one or more embodiments, the emulsification fork (100) may be operatively connected to an automation system (490). The automation system (490) may include a computer system such as computer system (600) as described in relation to FIG. 6. The automation system (490) may be configured with automation specific hardware and software for automating the emulsification fork (100). For example, the automation system (490) may include a robotic arm having a fork attachment, robotic arm members, servos, and motors configured to attach and maneuver the emulsification fork (100).

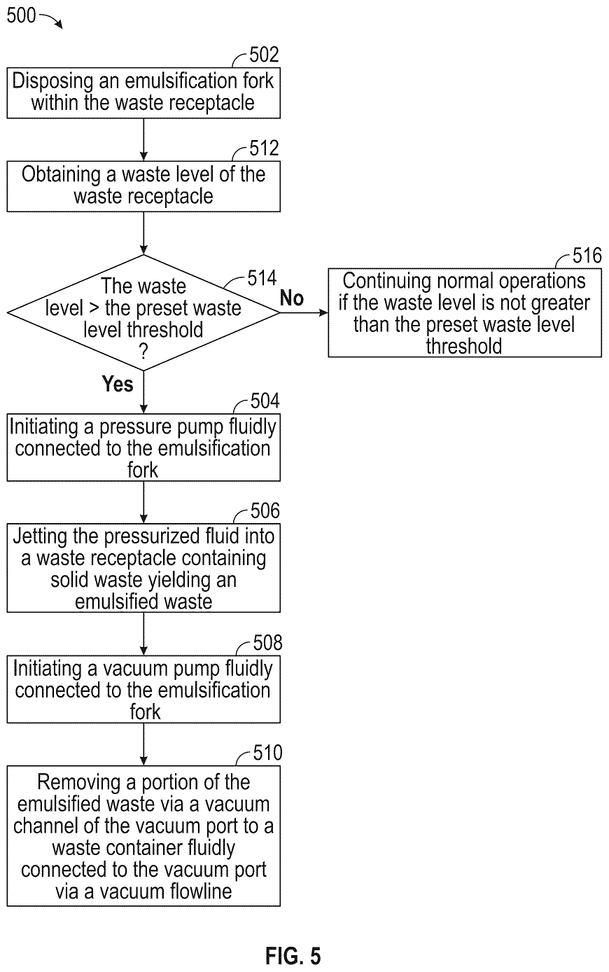

FIG. 5 depicts a cleaning flowchart in accordance with one or more embodiments describing a method for removing waste from a waste receptacle (hereafter “cleaning method” (500)). In some embodiments, the cleaning method (500) may use the cleaning system (400). Although the steps in flowchart using the cleaning method (500) are shown in sequential order, it will be apparent to one of ordinary skill in the art that some steps may be conducted in parallel, in a different order than shown, or may be omitted without departing form the scope of the invention.

In step (502), the cleaning method (500) includes disposing the emulsification fork (100) within the waste receptacle (140) in accordance with one or more embodiments. Disposing the emulsification fork (100) within the waste receptacle (140) may include disposing the emulsification fork (100) permanently. In some embodiments, disposing the emulsification fork (100) in the waste receptacle (140) may include disposing the emulsification fork (100) in the waste receptacle (140) only during cleaning operations and then removing the emulsification fork (100) from the waste receptacle (140) after cleaning operations have been completed.

In step (504), the cleaning method (500) includes initiating the pressurizing device (420) fluidly connected to the emulsification fork (100) and configured to pressurize the cleaning fluid (411) yielding the pressurized fluid (311) in accordance with one or more embodiments. Initiating the pressurizing device (420) may be initiated by instructions from the monitoring system (430) to the cleaning control system (434) due to input from the one or more sensors (417, 436, 437).

In step (506), the cleaning method (500) includes jetting, using the emulsification nozzle (210) of the emulsification fork (100), the pressurized fluid (311) into the waste receptacle (140) containing the waste (145) yielding the emulsified waste (313) in accordance with one or more embodiments. In some embodiments, emulsifying the waste (145) may include emulsifying only a portion of the waste (145) within the waste receptacle (140).

In step (508), the cleaning method (500) includes initiating the vacuum device (427) fluidly connected to the emulsification fork (100) and configured to provide suction to the vacuum port (220) of the emulsification fork (100) in accordance with one or more embodiments. Initiating the vacuum device (427) may be initiated by instructions from the monitoring system (430) to the cleaning control system (434) due to input from the one or more sensors (417, 436, 437).

In step (510), removing the portion of the emulsified waste (313) via the vacuum channel (321) of the vacuum port (220) to the waste container (415). In some embodiments, the cleaning method (500) includes operating the vacuum device (427) and the pressurizing device (420) simultaneously to emulsify the waste (145) and remove the portion of the emulsified waste (313) immediately after emulsification of the waste (145). In some embodiments, the cleaning method (500) includes operating the vacuum device (427) and the pressurizing device (420) simultaneously to emulsify the waste (145) and remove the portion of the emulsified waste (313) immediately after emulsification of the waste (145).

In step (512), the cleaning method (500) includes obtaining, using the receptacle sensor (437) communicably coupled to the monitoring system (430), the waste level (441) of the waste receptacle (140) in accordance with one or more embodiments. In some embodiments, communication may include sending electrical signals between various components of the cleaning system (400) along control lines (429) that may include cables, wires, and the like. In embodiments, communication may include sending wireless signals between various components of the cleaning system (400) with various components of the cleaning system (400) configured with wireless transmitters and receivers. In some embodiments, a combination of control lines and/or wireless communication may be utilized.

In step (514), the cleaning method (500) includes determining if the waste level (441) is greater than the preset waste level threshold (431) in accordance with one or more embodiments. In some embodiments, the cleaning method (500) includes initiating automatically the pressurizing device (420) and the vacuum device (427) to emulsify the waste (145) and remove the portion of the emulsified waste (313) from the waste receptacle (140) if the waste level (441) is greater than the preset waste level threshold (431).

In some embodiments, the cleaning method (500) may include controlling operations based on the determination if the waste level (441) is greater than the preset waste level threshold (431). Controlling operations may include, but not limited to, initiating cleaning operations for removal of the waste (145), initiating transport and discharge operations to empty the waste container (415), initiating treatment operations, recovery operations, recycling operations, and/or continuing normal operations.

In step (516), the cleaning method (500) includes continuing normal operations if the waste level (441) is not greater than the preset waste level threshold (431). For example, continuing normal operations may include continuing production of the production fluid (126) from the production well (101) and/or processing the production fluid (126) using the production plant (120).

In some embodiments, the cleaning method (500) includes initiating the alarm (433) of the monitoring system (430) if the receptacle sensor (437) senses the waste level (441) greater than the preset waste level threshold (431). Initiating the alarm (433) may further automatically initiate other operations such as cleaning operations, and transport and discharge operations to empty the waste container (415).

Embodiments may be implemented on a computer system. FIG. 6 is a block diagram of a computer system (600) used to provide computational functionalities associated with described algorithms, methods, functions, processes, flows, and procedures as described in the instant disclosure, according to an implementation. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other suitable formats. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604 includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602), and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

Embodiments of the present disclosure may provide at least one of the following advantages. Integrated emulsification and suction functions into a single apparatus improves efficiency and safety. The improved efficiency improves cost effectiveness and time saving. The time saving improves safety by reducing work hours needed for removing the waste from the waste receptacle and reduces risk of backup of waste to the detriment of the production facilities such as the production well and the production plant and possible environmental contamination. Embodiments may provide recycling and hydrocarbon recovery from the waste removed from the waste receptacle thereby reducing waste volume and removing toxic components for further practical use and/or treatment.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. An emulsification fork for removing waste from a waste receptacle, the emulsification fork comprising:
a fork body configured to transport a pressurized fluid;
a fork arm protruding from the fork body;
an emulsification nozzle fluidly coupled to the fork arm and configured to jet the pressurized fluid to emulsify the waste yielding an emulsified waste;
a pressurized fluid channel disposed throughout the fork body, the fork arm, and the emulsification nozzle and configured to transport the pressurized fluid;
a vacuum port disposed on the fork body and configured to remove a portion of the emulsified waste; and
a vacuum channel disposed throughout the vacuum port and configured to transport the portion of the emulsified waste.

2. The emulsification fork of claim 1, further comprising:
an additional fork arm protruding from the fork body; and
an additional emulsification nozzle fluidly coupled to the additional fork arm,
wherein the pressurized fluid channel disposed throughout the fork body, the additional fork arm, and the additional emulsification nozzle.

3. The emulsification fork of claim 1, further comprising:
an additional emulsification nozzle fluidly coupled to the fork arm.

4. The emulsification fork of claim 1, the emulsification fork further comprising:
a wheel disposed on the fork arm and configured to rotate and facilitate maneuvering of the emulsification fork.

5. The emulsification fork of claim 1, further comprising:
a quick-release latch configured to release the vacuum port from the emulsification fork.

6. A cleaning system for removal of waste from a waste receptacle, the cleaning system comprising:
an emulsification fork comprising:
a fork body configured to transport a pressurized fluid;
a fork arm protruding from the fork body;
an emulsification nozzle fluidly coupled to the fork arm and configured to jet the pressurized fluid to emulsify the waste yielding an emulsified waste;
a pressurized fluid channel disposed throughout the fork body, the fork arm, and the emulsification nozzle and configured to transport the pressurized fluid;
a vacuum port disposed on the fork body and configured to remove a portion of the emulsified waste; and
a vacuum channel disposed throughout the vacuum port and configured to transport the portion of the emulsified waste,
wherein the emulsification fork is configured to be disposed within the waste receptacle;
a pressurizing device fluidly connected to the emulsification fork via a fluid flowline and configured to pressurize a cleaning fluid; and
a vacuum device fluidly connected to the vacuum port and configured to provide suction to the vacuum port.

7. The cleaning system of claim 6, further comprising:
a receptacle sensor disposed in the waste receptacle and configured to obtain a waste level of the waste receptacle; and
a monitoring system communicably coupled to the receptacle sensor and configured to automatically initiate the pressurizing device and the vacuum device to emulsify the waste and remove the portion of the emulsified waste from the waste receptacle if the waste level is greater than a preset waste level threshold.

8. The cleaning system of claim 6, further comprising:
a fluid reservoir fluidly connected to the pressurizing device and configured to store the cleaning fluid.

9. The cleaning system of claim 8, further comprising:
a reservoir sensor configured to monitor a fluid level of the fluid reservoir; and
a monitoring system communicably coupled to the reservoir sensor and configured to monitor the reservoir sensor.

10. The cleaning system of claim 6, further comprising:
a waste container fluidly connected to the vacuum device via a vacuum flowline and configured to store the portion of the emulsified waste removed from the waste receptacle.

11. The cleaning system of claim 6, wherein the vacuum device and the pressurizing device are configured to operate
simultaneously to emulsify the waste and remove the portion of the emulsified waste.

12. The cleaning system of claim 6, wherein the emulsification fork further comprises:
an additional fork arm protruding from the fork body; and
an additional emulsification nozzle fluidly coupled to the additional fork arm, wherein the pressurized fluid channel disposed throughout the fork body, the additional fork arm, and the additional emulsification nozzle.

13. The cleaning system of claim 6, wherein the emulsification fork further comprises:
an additional emulsification nozzle fluidly coupled to the fork arm.

14. The cleaning system of claim 6, wherein the emulsification fork further comprises:
a wheel disposed on the fork arm and configured to rotate and facilitate maneuvering of the emulsification fork.

15. A method for cleaning a waste receptacle, the method comprising:
disposing an emulsification fork within the waste receptacle;
initiating a pressurizing device fluidly connected to the emulsification fork and configured to pressurize a cleaning fluid yielding a pressurized fluid;
jetting, using an emulsification nozzle of the emulsification fork, the pressurized fluid into the waste receptacle containing waste yielding an emulsified waste;
initiating a vacuum device fluidly connected to the emulsification fork and configured to provide suction to a vacuum port of the emulsification fork; and
removing a portion of the emulsified waste via a vacuum channel of the vacuum port to a waste container fluidly connected to the vacuum port via a vacuum flowline.

16. The method of claim 15, further comprising:
operating the vacuum device and the pressurizing device simultaneously to emulsify the waste and remove the portion of the emulsified waste immediately after
emulsification of the waste.

17. The method of claim 15, further comprising:
obtaining, using a receptacle sensor communicably coupled to a monitoring system, a waste level of the waste receptacle;
determining if the waste level is greater than a preset waste level threshold; and
controlling operations based on a determination if the waste level is greater than the preset waste level threshold.

18. The method of claim 17, further comprising:
initiating automatically the pressurizing device and the vacuum device to emulsify the waste and remove the portion of the emulsified waste from the waste receptacle if the waste level is greater than the preset waste level threshold.

19. The method of claim 17, further comprising:
initiating an alarm of the monitoring system if the receptacle sensor senses the waste level greater than the preset waste level threshold.

20. The method of claim 17, further comprising:
continuing normal operations if the waste level is not greater than the preset waste level threshold.
